(19) United States
(12) Patent Application Publication
(10) Pub. No.: US 2018/0158089 A1
(43) Pub. Date: Jun. 7, 2018

(54) SELFEE Social Media Nano&#8208;influencer Tracking and Reward System and Method

(71) Applicant: Guifre Tort, San Juan, PR (US)

(72) Inventor: Guifre Tort, San Juan, PR (US)

(21) Appl. No.: 15/831,410

(22) Filed: Dec. 5, 2017

Related U.S. Application Data
(60) Provisional application No. 62/430,365, filed on Dec. 6, 2016.

(51) Int. Cl. G06Q 30/02; G06Q 50/00

(52) U.S. Cl. CPC G06Q 30/0218; G06K 2209/25; G06Q 30/0276; G06Q 50/01

(57) ABSTRACT

Systems and methods for the identification, tracking and rewarding of natural, organic and authentic social media digital branded content by influencers, and particularly of Nano-influencers. Monitoring and rewarding mechanisms and criteria are based on a selected subject-matter, so that the analysis permits quantification of influencers and takes into account the desire of promoters to have their areas of influence commented on social media.

### CROSS-REFERENCE TO RELATED APPLICATIONS

This application claims priority to co-pending U.S. Provisional patent application Ser. No. 62/430,365 titled “SELFEE System and Method”, filed on Dec. 6, 2016 the disclosure of which is herein incorporated by reference in its entirety.

### PATENTS CITED

The following documents and references are incorporated by reference in their entirety, Aven et al (U.S. Pat. No. 8,843,406), Paul et al (U.S. Pat. Pub. No. 2009/0063254) and Kumar et al (U.S. Pat. No. 9,418,391).

### FIELD OF THE INVENTION

The present invention relates to a system and method for the tracking and reward of social media influencers, and particularly to a system/method to steer, track and reward Nano-influencers within social media by advertisers/promoters.

### DESCRIPTION OF THE RELATED ART

Social media has revolutionized the world, particularly interpersonal interactions. By social media we refer to the electronic transmitting of information within a larger audience of users having a common social network. Social networks are electronic platforms that allow users in different locations to engage, interact, communicate and collaborate between them. These users are typically absorbed in social media from five to seven hours per day, consuming network content. They hate ads or sponsored content, usually watching less than 14% of the ads shown to them over the internet. They are loyal to brand, not ‘stuff’, with 78% saying social media posts impact their purchases. In short, 71% are more likely to purchase based on social media referrals.

In order to influence a member's opinion, companies look to identify key influencers. The term ‘influencer’, as used herein, means a member who transmits information, through social media channels, that have an impact on other member's ideas and practices. Members of the social media who get the most attention may be considered as influencers for a particular topic on a social media channel. These members have the power to affect other member's opinions, and thus their perception of the brand and purchase decisions. Influence is dynamic and depends on variety of factors for example, perceived authority and audiences reach. Influential zones can be found across social media, for example, Facebook®, Twitter®, other social media platforms, blogs and forums by applying social network analysis technics.

The unknown hero of social marketing is the Nano-influencer, influencers that have less than 50,000 followers (a lightly engaged active audience), have over 12% engagement rates per post, invests about 220 hours per month in social media, have about 750 individual posts a month, share content in two or more social networks, provide over 20 times the recommendations a week than the average consumer and 82% of their audience follow their recommendations, because 58% of these followers feel they can relate to them.

What is needed, a mobile application that allows sponsors to steer and reward these Nano-influencers by incentivizing them to capture their real behavior with brands, target them and promote awareness and sales and reach across multiple networks.

### SUMMARY OF THE INVENTION

This section is for the purpose of summarizing some aspects of the present invention and to briefly introduce some preferred embodiments. Simplifications or omissions may be made to avoid obscuring the purpose of the section. Such simplifications or omissions are not intended to limit the scope of the present invention.

In one aspect the invention is about a method for tracking and rewarding social media influencers, said method comprising capturing by the camera of an electronic computing device an image, with the electronic computing device ensuring the capture of available geolocation and/or time information, and user comments and input, manual or automated including recognition of content, brand(s) and/or persons in image, uploading said image to one or more SELFEE server computing devices, wherein said images are checked for appropriate content, manual or automated recognition of brand(s) logo/products/people, correct time/place and approval for reward tracking, posting said images to one or more social media networks, tracking replies to user posted images in one or more social media networks and calculating rewards per user; and remitting rewards to users. In another aspect, the computing device camera is under the explicit control of the SELFEE application on said computing device. In yet another aspect, images having one or more person(s) besides the user in them are not approved by the SELFEE system for reward tracking until said one or more person(s) authorize their use to the SELFEE system.

In one aspect, the invention is about a Social Media influencer tracking and rewarding system comprising one or more processors, a memory, wherein the memory coupled to the one or more processors which are configured to execute programmed instructions stored in the memory comprising: receiving a data set comprising at least one selected topic, capturing by the camera of an electronic computing device an image, with the electronic computing device ensuring the capture of available geolocation and/or time information, and user comments and input, manual or automated including recognition of content, brand(s) and/or persons in image, uploading said image to one or more SELFEE server computing devices, wherein said images are checked for appropriate content, manual or automated recognition of brand(s) logo/products/people, correct time/place and approval for reward tracking, posting said images to one or more social media networks, tracking replies to user posted images in one or more social media networks and calculating rewards per user and remitting rewards to users. In another aspect, the computing device camera is under the explicit control of the SELFEE application on said computing device. In yet another aspect, images having one or more person(s) besides the user in them are not approved by the SELFEE system for reward tracking until said one or more person(s) authorize their use to the SELFEE system.

In one aspect the invention is about a non-transitory computer readable medium having stored thereon instructions for tracking and rewarding at least one influencer comprising machine executable code which when executed by at least one processor, causes the processor to perform steps comprising: capturing by the camera of an electronic computing device an image, with the electronic computing device ensuring the capture of available geolocation and/or time information, and user comments and input, manual or automated including recognition of content, brand(s) and/or persons in image, uploading said image to one or more SELFEE server computing devices, wherein said images are checked for appropriate content, manual or automated recognition of brand(s) logo/products/people, correct time/place and approval for reward tracking, posting said images to one or more social media networks, tracking replies to user posted images in one or more social media networks and calculating rewards per user and remitting rewards to users. In another aspect, the computing device camera is under the explicit control of the SELFEE application on said computing device. In yet another aspect, images having one or more person(s) besides the user in them are not approved by the SELFEE system for reward tracking until said one or more person(s) authorize their use to the SELFEE system.

Other features and advantages of the present invention will become apparent upon examining the following detailed description of an embodiment thereof, taken in conjunction with the attached drawings.

### BRIEF DESCRIPTION OF THE DRAWINGS

FIG. 1 is an illustration of the prior art.

FIG. 2 shows an illustration of the SELFEE system topography, according to an exemplary embodiment of the invention.

FIG. 3 shows a step-by-step illustration of the SELFEE operation, according to an exemplary embodiment of the invention.

FIG. 4 shows the SELFEE consumer, according to an exemplary embodiment of the invention.

FIGS. 5A-5B show some of the SELFEE application features and perks, according to an exemplary embodiment of the invention.

FIG. 6 shows exemplary SELFEE Payment Levels, according to an exemplary embodiment of the invention.

FIG. 7 shows the SELFEE User/Brand representation, according to an exemplary embodiment of the invention.

FIG. 8 shows the SELFEE user registration process, according to an exemplary embodiment of the invention.

FIG. 9 shows the SELFEE image process, according to an exemplary embodiment of the invention.

FIG. 10 shows the SELFEE Interaction and Payout analysis process, according to an exemplary embodiment of the invention.

FIG. 11 shows an exemplary SELFEE brand showcase screen, according to an exemplary embodiment of the invention.

FIG. 12 shows the SELFEE friend selection screen, according to an exemplary embodiment of the invention.

FIG. 13 shows the SELFEE example for a L'Oreal campaign, according to an exemplary embodiment of the invention.

FIG. 14 shows the SELFEE user images, according to an exemplary embodiment of the invention.

FIG. 15 shows an image for the SELFEE brand manager utility, according to an exemplary embodiment of the invention.

The above-described and other features will be appreciated and understood by those skilled in the art from the following detailed description, drawings, and appended claims.

### DETAILED DESCRIPTION OF THE PREFERRED EMBODIMENT

This section is for the purpose of summarizing some aspects of the present invention and to briefly introduce some preferred embodiments. Simplifications or omissions may be made to avoid obscuring the purpose of the section. Such simplifications or omissions are not intended to limit the scope of the present invention.

To provide an overall understanding of the invention, certain illustrative embodiments and examples will now be described. However, it will be understood by one of ordinary skill in the art that the same or equivalent functions and sequences may be accomplished by different embodiments that are also intended to be encompassed within the spirit and scope of the disclosure. The compositions, apparatuses, systems and/or methods described herein may be adapted and modified as is appropriate for the application being addressed and that those described herein may be employed in other suitable applications, and that such other additions and modifications will not depart from the scope hereof.

Simplifications or omissions may be made to avoid obscuring the purpose of the section. Such simplifications or omissions are not intended to limit the scope of the present invention. All references, including any patents or patent applications cited in this specification are hereby incorporated by reference. No admission is made that any reference constitutes prior art. The discussion of the references states what their authors assert, and the applicants reserve the right to challenge the accuracy and pertinence of the cited documents. It will be clearly understood that, although a number of prior art publications are referred to herein, this reference does not constitute an admission that any of these documents form part of the common general knowledge in the art.

As used in the specification and claims, the singular forms “a”, “an” and “the” include plural references unless the context clearly dictates otherwise. For example, the term “a transaction” may include a plurality of transaction unless the context clearly dictates otherwise. As used in the specification and claims, singular names or types referenced include variations within the family of said name unless the context clearly dictates otherwise.

Certain terminology is used in the following description for convenience only and is not limiting. The words “lower,” “upper,” “bottom,” “top,” “front,” “back,” “left,” “right” and “sides” designate directions in the drawings to which reference is made, but are not limiting with respect to the orientation in which the modules or any assembly of them may be used.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

The SELFEE App encompasses multiple innovative and new technology in a one of a kind user incentive social platform, which permits massive scalability and adaptation. With unique algorithms we are able to link user's social media, do face, logo and content recognition and with the user permission track their social media interactions in order to compile very important data that is analyzed to determine that user's digital footprint and rewards.

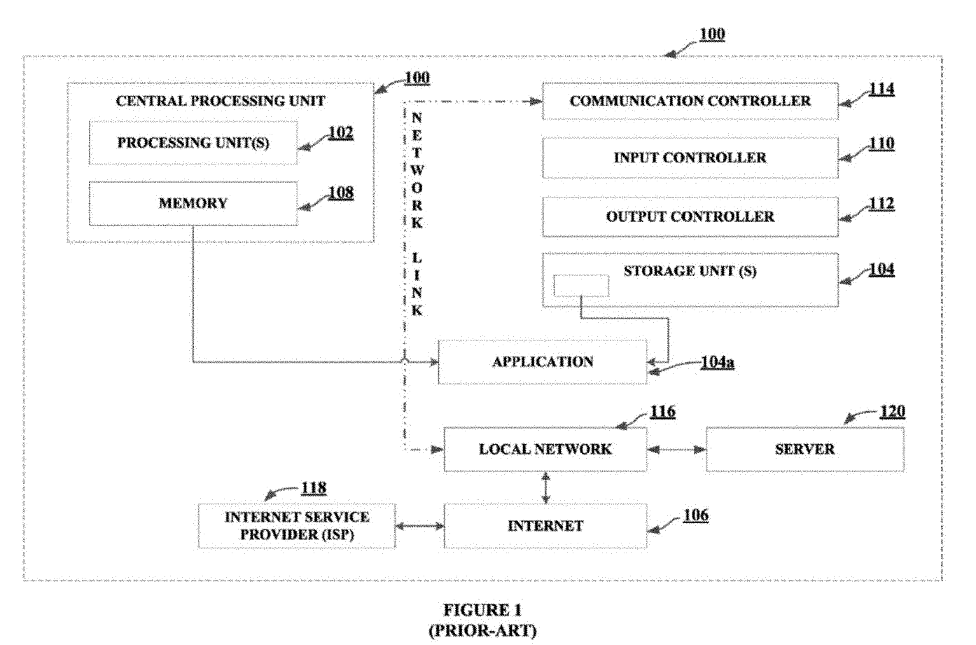

FIG. 1 (PRIOR-ART) is a block diagram of a computing device 100 to which the present disclosure may be applied according to an embodiment of the present disclosure. The system includes at least one processor 102, designed to process instructions, for example computer readable instructions (i.e., code) stored on a storage device 104. By processing instructions, processing device 102 may perform the steps and functions disclosed herein. Storage device 104 may be any type of storage device, for example, but not limited to an optical storage device, a magnetic storage device, a solid-state storage device and a non-transitory storage device. The storage device 104 may contain an application 104a which is a set of instructions (i.e. code). Alternatively, instructions may be stored in one or more remote storage devices, for example storage devices accessed over a network or the internet 106.

The computing device also includes an operating system and microinstruction code. The various processes and functions described herein may either be part of the microinstruction code or part of the program (or combination thereof) which is executed via the operating system. Computing device 100 additionally may have memory 108, an input controller 110, and an output controller 112 and communication controller 114. A bus (not shown) may operatively couple components of computing device 100, including processor 102, memory 108, storage device 104, input controller 110 output controller 112, and any other devices (e.g., network controllers, sound controllers, etc.). Output controller 110 may be operatively coupled (e.g., via a wired or wireless connection) to a display device (e.g., a monitor, television, mobile device screen, touch-display, etc.) in such a fashion that output controller 110 can transform the display on display device (e.g., in response to modules executed).

Input controller 108 may be operatively coupled (e.g., via a wired or wireless connection) to input device (e.g., mouse, keyboard, touch-pad, scroll-ball, touch-display, etc.) in such a fashion that input can be received from a user. The communication controller 114 is coupled to a bus (not shown) and provides a two-way coupling through a network link to the internet 106 that is connected to a local network 116 and operated by an internet service provider (hereinafter referred to as ‘ISP’) 118 which provides data communication services to the internet. Members or subscribers of social media may be connected to the local network 116. A network link typically provides data communication through one or more networks to other data devices. For example, network link may provide a connection through local network 116 to a host computer, to data equipment operated by an ISP 118. A server 120 may transmit a requested code for an application through internet 106, ISP 118, local network 116 and communication controller 114.

Of course, FIG. 1 illustrates computing device 100 with all components as separate devices for ease of identification only. Each of the components may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing device 100 may be one or more servers, for example a farm of networked servers, a clustered server environment, or a cloud network of computing devices.

In various exemplary embodiments, an application 104 a or service, typically operating on a host site (for example, a website) to facilitate social media platform management and influence scoring for a member at a platform. The platform may be a Social network's ‘published platform’ or similar platform. Each type of platform provides for a plurality of content channels of which a user may become a member.

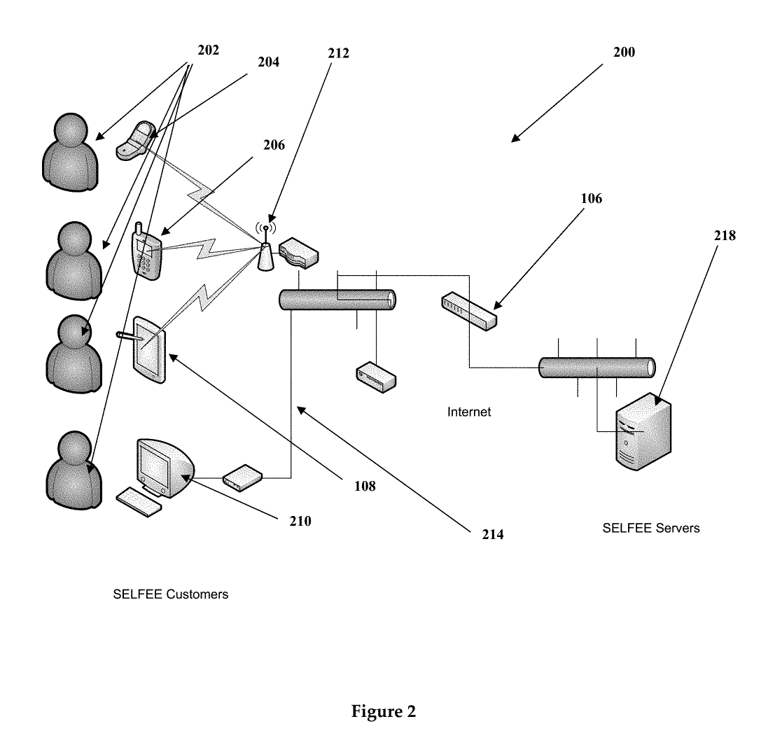

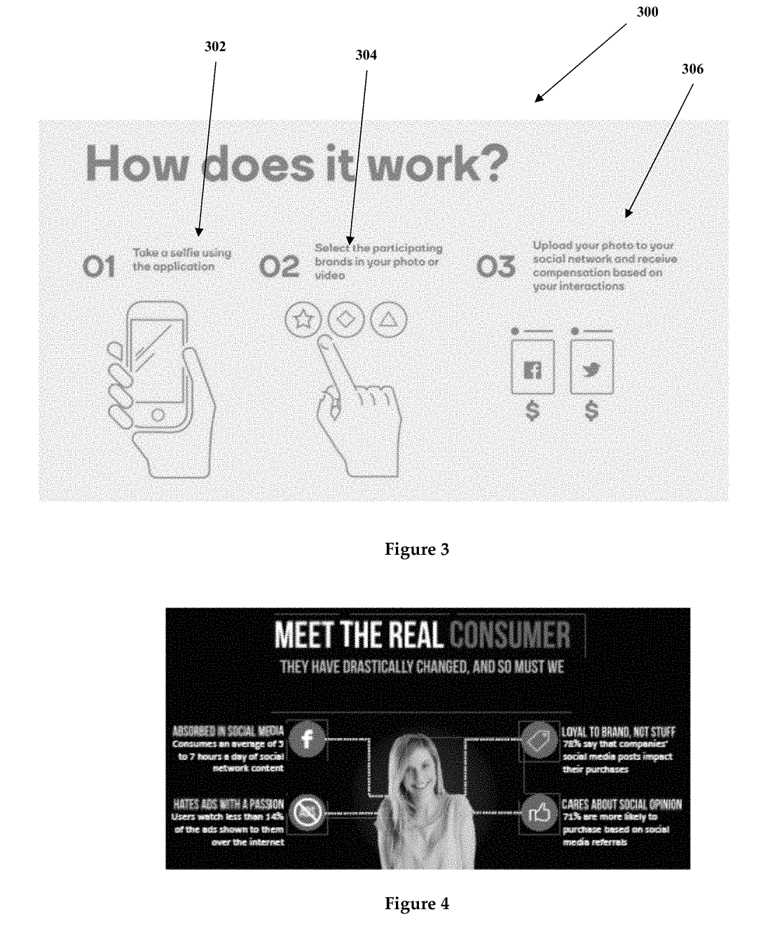

Referring to FIG. 2 we see an exemplary embodiment of the SELFEE system topography 200. A critical part of SELFEE is a mobile application that rewards those that influence others through their social media interactions via their images (still image/video solution/GIF or any future similar audiovisuals). The SELFEE system begins by incentivizing users 102 to capture and share their real behavior with THEIR brands. In social media, influencers are those have 1 million or more followers (e.g., Shakira, Kim Kardashian). Micro influencers are those that have more than 50 thousand followers, but less than a million (Perez Hilton and others). SELFEE targets Nano-influencers 102, those that have more than 2, but less than 50,000 followers, by promoting awareness and sales, while reaching out through their own networks, generating views, comments, shares and all other kinds of interactions from their followers, friends and users which span across multiple social media networks and platforms.

SELFEE allows for the creation of digital content so that can share these across social media in an organic manner. In many of these graphical images (again, still video, video, GIF, etc., brands/products/services appear as part of a consumer's daily lives. Although many brands value this relationship with consumers and potential consumers, they are not aware of the creation of this specific content. Through SELFEE these brands can detect and then reward these consumers generating the ‘vibe’ about their product, and become aware of trends within sub-groups that may be occurring below their marketing departments radar.

Each SELFEE client/user 102 has one or more electronic computing devices 100, such as Smartphone 204, Smartphones 206, Tablets 208, computers 210 and others similar devices) connected to the one or more SELFEE servers 218 (themselves also computing devices 100) through mobile 212 and/or fixed 214 components (3G, 4G, 4G LTE and other wireless methods as well as Cable/Fiber and other cabled connections), across the Internet 116. The one or more SELFEE servers 218, which connect the users through the SELFEE system to the both the sponsor/advertisers and the Social Media Networks (as well as the devices direct connection to the same Social Media Networks). For the SELFEE App to work at a peak performance we integrate diverse platforms that each have individual capabilities in order to have a complete Big Data and User Rewards system.

In one proposed embodiment (FIG. 2), SELFEE does this through four simple steps 300 once a user is registered (register implies that the user in order to create his or her profile has to put an authentic email address, personal information, take a profile picture using the SELFEE app build in camera at that precise moment and link his o her social networks) with the SELFEE app. Step #1 302; Take a SELFEE using the application (which interfaces to the device camera interfaces) and choose one of the build in image filters, if any. Step #2 write a description of the users post (including respecting limitations such as character limits depending on the social network chosen to share the content) and choose the one or more social networks in which to share your post. Step #3 304 choose which brands appear on your content or choose which event represents the best the content of the post. Step #4 306 Upload the image (again, wherein this image may be comprised of still/video/GIF/or other valid image/video formats, etc.) to your selected Social Media platforms (Facebook, Twitter, Instagram, etc.), then let the SELFEE system track after a sharing period, the interactions with your image and add credits to your account, which you then exchange for money!

An important distinction between using a camera to post images and the SELFEE system, is that the device camera, is under exclusive control of the SELFEE application as to the result of the camera image. That is, no image will be accepted by the SELFEE system unless the image has been taken by the SELFEE app. This is to prevent fraud, making sure the image was taken by the user at the moment of consumption, as well as to include (when possible) geolocation, date/time, Face recognition of those in the image, etc. with the image file. In this fashion, patrons claiming to be at a festival can be confirmed in space and time. Once an image is taken, the image may not be uploaded to the SELFEE servers 118 until appropriate internet exists, being held in the device until that time.

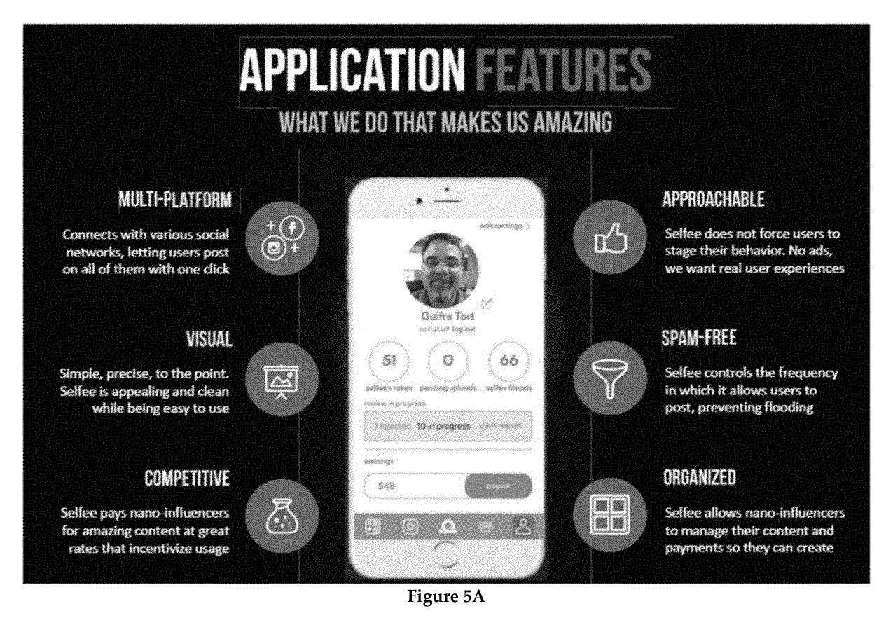

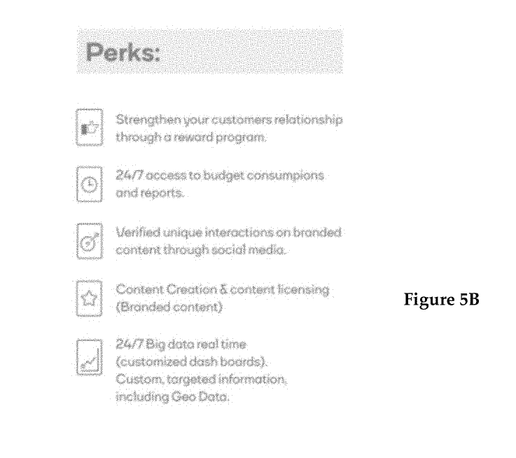

Note, that you can also find friends through the app, through your contact list or through your social network contacts, to share and invite to SELFEE. The SELFEE system (FIG. 5A) allows the user's input to be multi-platform, allowing the users to see the same User Interface across devices (be it a Smartphone (iPhone, Android, etc.), Tablet (iPad, Galaxy, etc.), accessory camera (wired or wireless), drone, selfie stick or other device (mobile or fixed), device operating system (be it Apple, Android, Chrome, Microsoft or any other similar operating system). Similarly, it connects to one or more social networks (Facebook, Twitter, Instagram, etc.), through a visual user interface that is appealing, easy to use, and as language independent (English, Spanish, Chinese Mandarin, Chinese Cantonese, Japanese, French, etc.) as possible.

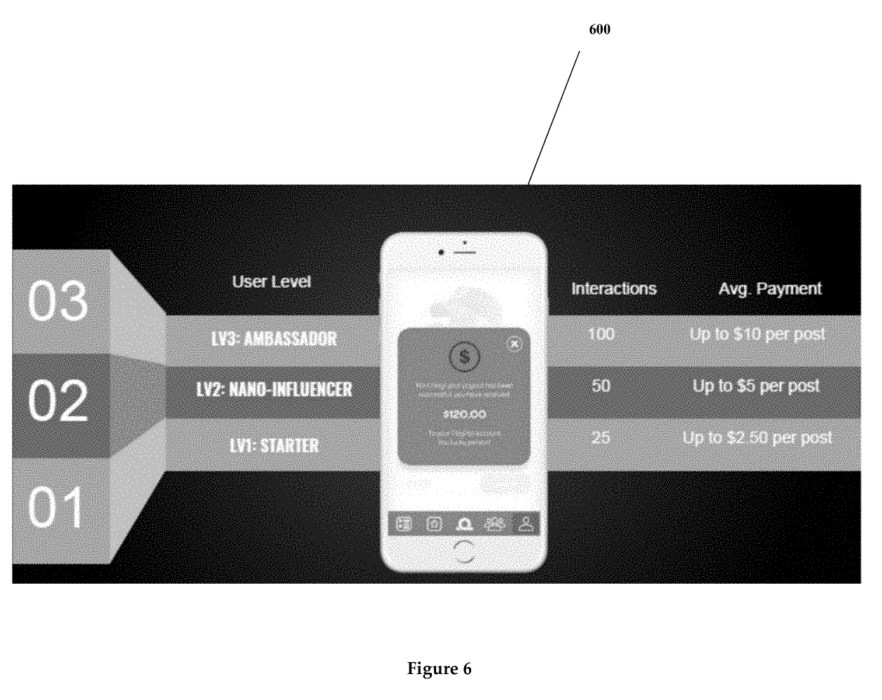

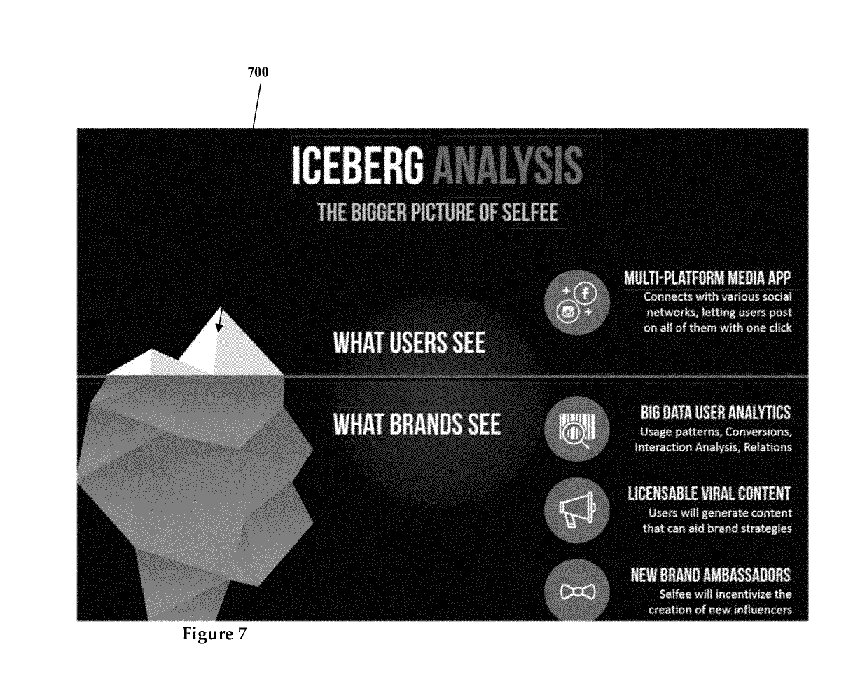

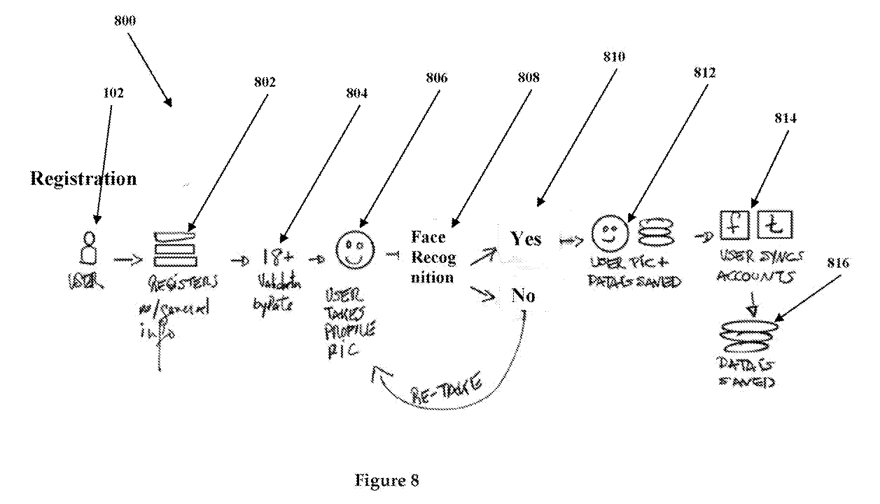

In one embodiment, SELFEE pays the Nano-influencers for amazing content creation and data at great rates, incentivizing usage (FIGS. 4-8). It is approachable, in that it does not force users to stage their behavior, in short, they are not ads, but the real experience of users. As such, it can be Spam-Free, since the SELFEE system (implemented in the various apps residing within the devices 204-210 as well as the servers 218) which control the frequency of postings, preventing intentional or accidental flooding. Finally, it is organized, allowing the users to manage their content and payments, so they can create valuable content.

The SELFEE system provides a number of important benefits and perks to the brands, in particular for its organic and ‘person to person’ nature. You are not receiving an ‘advertisement’, you're having your friend Pablo tell you about the great sneakers he just got (consciously through his comment, and subconsciously because you can see him wearing the shoes in the image!). In short, the consumer/client is telling the story! The many perks (FIG. 5B) of the SELFEE system include, strengthening the customer relationship through a reward program, 24/7 access to budget consumption/reports (on the SELFEE brand management application side), verified unique interactions of branded content, content creation and content licensing and 24/7 big data real time dashboards for brand managers.

In one proposed embodiment 600, there are three payment levels, 01-03. A Level 01 (LV1) influencer is a Starter, with 25 interactions, getting remunerated at an entry level, say up to $2.50 dollars (or equivalent currency) per post. A Level 02 (LV2) user (a Nano-Influencer level, not to be confused with the general term Nano-influencer which applies to all users getting traction from their posts) has more than 25 and up to 50 interactions, and is getting paid at up to $5 per post. A level 03 (Ambassador) user has more than 100 interactions, getting up to $10 per post.

It can be appreciated by those skilled in the art that the number/terms for each level may be almost infinite, but that the importance lies in the stratification of rewards, in effect rewarding success and the identification of those Nano-influencers within groups. It may be also be appreciated that the process of tracking posts interactions across platforms, and then calculating and posting the rewards for potentially hundreds (maybe thousands) of photos/videos/GIF is far from a ‘simple’ mental process, particularly when the SELFEE system tracks/detects the faces/features of friends/brands automatically and inappropriate content within the image.

A system like SELFEE is of course happy to have mega influencers (e.g. Kim Kardashian), but in reality, it is more about increasing the visibly (and tracking the response to) of Nano-influencers 202. These may include ‘stairway to success’ and any other such compensation scheme.

Of course, any system such as SELFEE must get remuneration itself in order to pay the influencers. How is this done? In one embodiment 700, the SELFEE System has three proposed levels for advertisers to come in. At $10,000 per month, a sponsor is a “Standard” supporter, having an entry level package for brands that are just ‘getting’ into social influencer media. As such, for the $10K, they get up to 1,000 (Or any other metric beneficial for the brands such as the sum of all Reach, Views and Interactions) posts per month, monthly reports and access to posted media. Above this, a “Pro” level sponsor pays $20,000/month, and is designed for brands that want to know their consumers. They see up to 2,000 posts a month (Or any other metric beneficial for the brands such as the sum of all Reach, Views and Interactions), get monthly or weekly reports and have access to the posted media.

Finally, an upper level is for the SELFEE “Business”, a premium package that allows the brands to customize their engagements, see up to 5,000 posts per month (Or any other metric beneficial for the brands such as the sum of all Reach, Views and Interactions), get monthly, weekly or daily reports and have ownership of the posted media.

When we compare what goes on, we can imagine an iceberg 750. Users see the (usual) 10% above the water, that is, they get rewarded for participating in a multi-platform media app that allows them to connect with various social networks, letting them post on all the selected networks with a single click. Brands, on the other hand, pay to see Big Data User analytics (usage patterns, conversions, interaction analysis and relations, demographics, location amongst other things); Licensable Viral Content (User generated content that can aid brand strategies) and New Brand Ambassadors (SELFEE created and incentivized new influencers). All of this may be shown and updated as frequently as necessary (into even real time) to the actual brand manager via the SELFEE data display tool.

To begin using the system, a user 202 begins by using one or more of their devices to register 800 with the SELFEE, with this process being hosted with software both in the device (an App) and within the one or more SELFEE servers 218. These first-time users are shown a small step by step explanation of the purpose of the app (3-4 steps). The user 202 enters their general information 902, and their age is validated 904.

The user then takes a profile picture 806 which is face recognized, since users are going to be rewarded for their content. In short, we need to make sure that the user is who he or she says he is. So, each content taken with SELFEE gets scanned by our Face recognition technology (FRT) 808 to verify that the face in the content matches the face in the user profile. FRT also scans for other faces in the content in order to identify who they are. If the main user takes a picture with other people around, our system will recognize them and ask user to identify them in order to approve the content and reward the user. If a person inside the photograph does not approve the content, the main user does not get rewarded nor the content is approved. If the image is felt to be sub-standard, the user is asked to retake it 810.

The user then makes their user pic official 812, and the rest of the data is saved. At this time, the user selects syncing options for his/her Facebook/Twitter and other social networks 814, so that when images are taken and registered with SELFEE, they are automatically posted to the Social Networks and their responses 816 tracked by the SELFEE servers and reported to the user.

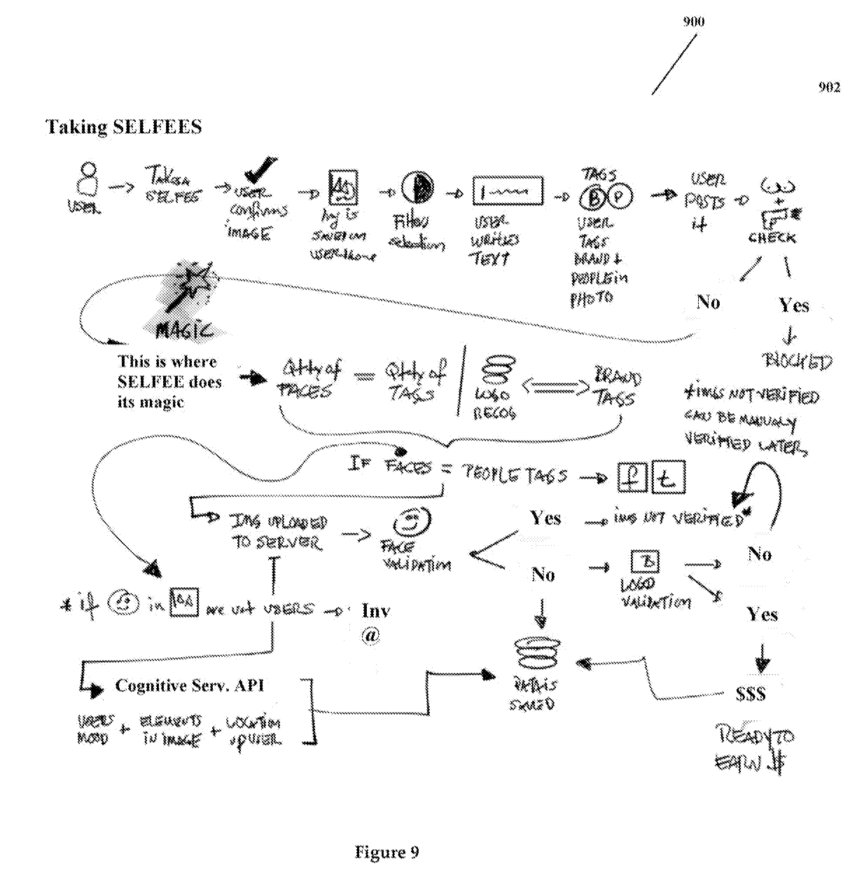

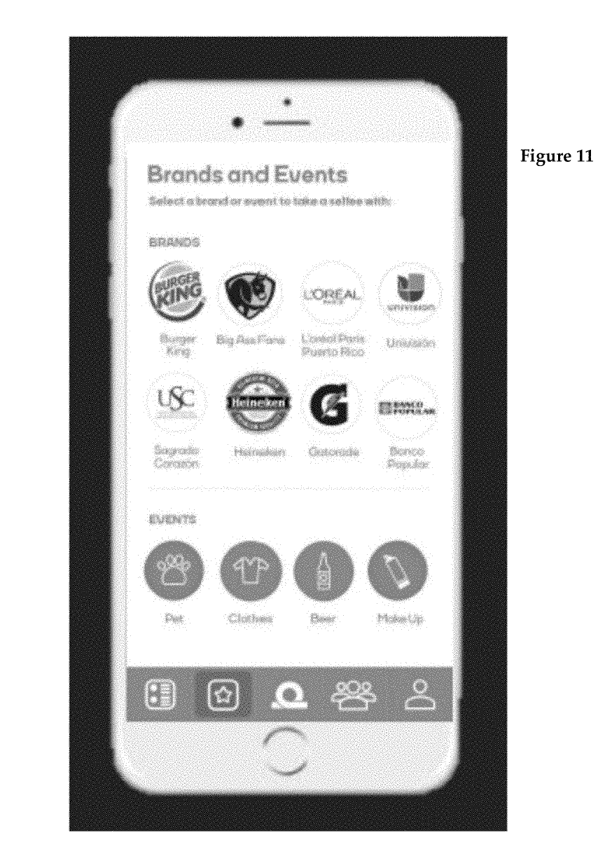

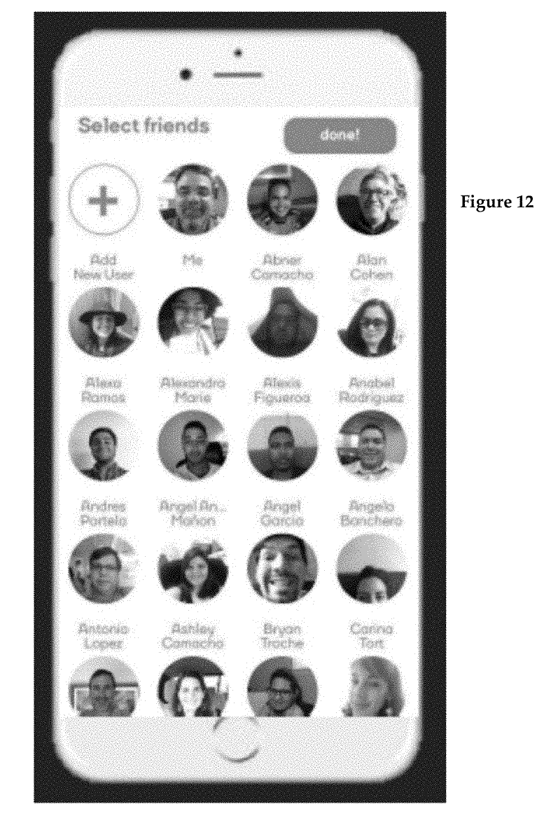

FIG. 9 illustrates the Taking SELFEEs process 900. A user 102 takes a SELFEE and confirms the quality/content of the image, confirming the desire to use it as his SELFEE image. The image is saved in the user's home (both within the device (104, 106, 108, 110) as within the SELFEE programs within the SELFEE servers (essentially creating a redundant image file). The user 102 selects image processing filters (Black and White, Vintage, etc.), enters data about the SELFEE image, and tags the BRANDS screen(s) and people in the image (FIGS. 11-12).

Note that the user may confirm the brand, enter it, or have the software identify the brand for user confirmation. This selection may be based on a participating brand already selected, based on the user's sponsor opportunities (advertisers who make offers to users), or based on the offers available to SELFEE. In one embodiment, the product to be highlighted is selected by the user and/or the table is weighed to place those products paying a higher referral fee/reward first. In an alternate embodiment, the SELFEE system (either as an App within the user's device and/or as the image is uploaded to the SELFEE system servers) processes the image using image recognitions software (such as LOGOGRAB or other software capable of detecting all the brands within the image) and automatically suggests/selects the one or more brands to the user (based on SELFEE sponsors), to ensure that no suitable product SELFEE is overlooked. In this fashion, if the user claims that a COCA-COLA logo is in the image, but the system cannot detect it, the SELFEE is posted, but no financial credit occurs.

In addition, if other brands ‘show’ in a lot of SELFEE user's, SELFEE may use this collected data to suggest to the owners of those brands that they should become SELFEE customers! Similarly, the system may have an image gallery, where a Nano-influencer's images are ranked by likes, or those related to a brand are similarly ranked, etc.

Other similar actions based on the information within the image include using a face recognition algorithm to identify both the posting person, as well as any other SELFEE members within an image. In this fashion, in one embodiment an auto release (to agree to be within a published image) may be obtained and/or a face may be blurred if the recognized person so desires. Similarly, automated emoticon detection may add to the image by recognizing (automatically and/or human assisted) the emotion of the faces. Finally, a text message context recognition application may assist in the big data gathering of the responses from the Nano-influencer's followers to the posting, assisting the brand or advertiser in gauging whether the response to the SELFEE is positive, negative, related to a particular hash mark or event, etc.

Note that a system function (performed by either the device or the server 118 will be the automate/assisted detection 902 of inappropriate content (Women flashing, Nudity, Violence, phallic images, obscene or other inappropriate behavior). This is accomplished automatically by the SELFEE servers 118 in embodiment, or may be accomplished by personnel located remotely and shown the images. If the image is blocked, it may automatically go to the human evaluator. Once the image is seen as appropriate, the SELFEE system automatically calculates the quantity of faces (running the FRT), and similarly recognizes the other Logos.

In one embodiment, the images are then uploaded to the servers 218, where the Cognitive Services API proceeds to detect the User's Moods, Elements in images and the location of the device (204, 206, 208, 210). At this time, if the detected user is found not to be in the SELFEE system 904, they are invited via email, SMS, WhatsApp, Messenger of similar information (based on the User's Emails/Contacts, as well as independent SELFEE data) to join SELFEE.

While an image may be posted by SELFEE into Social Media if all the detected people are not found, no financial reward for the image is paid by SELFEE to the influencer until the people identified (be they by the user or by the SELFEE face recognition software become SELFEE members themselves, for part of the inclusion in SELFEE includes signing a release to SELFEE that allows the use by sponsors of the images paid for by SELFEE in advertising campaign.

If the user in the image, is found to be part of SELFEE already 906, their Social Media responses (Likes, retweets, etc.), in combination with the Promotions from the advertisers related to the Logos is taken into account to calculate 908 the level of their reward and credit their accounts.

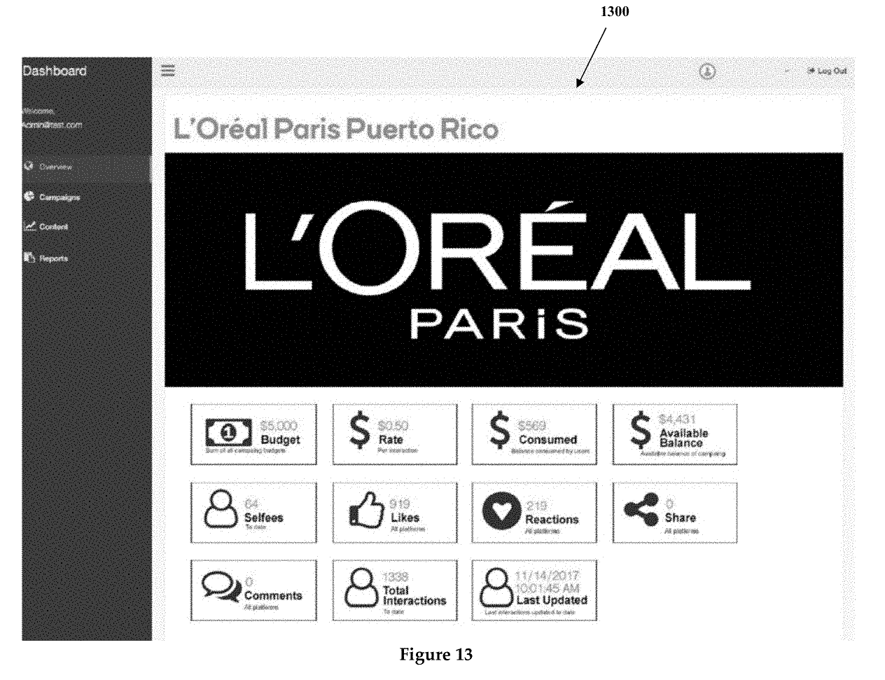

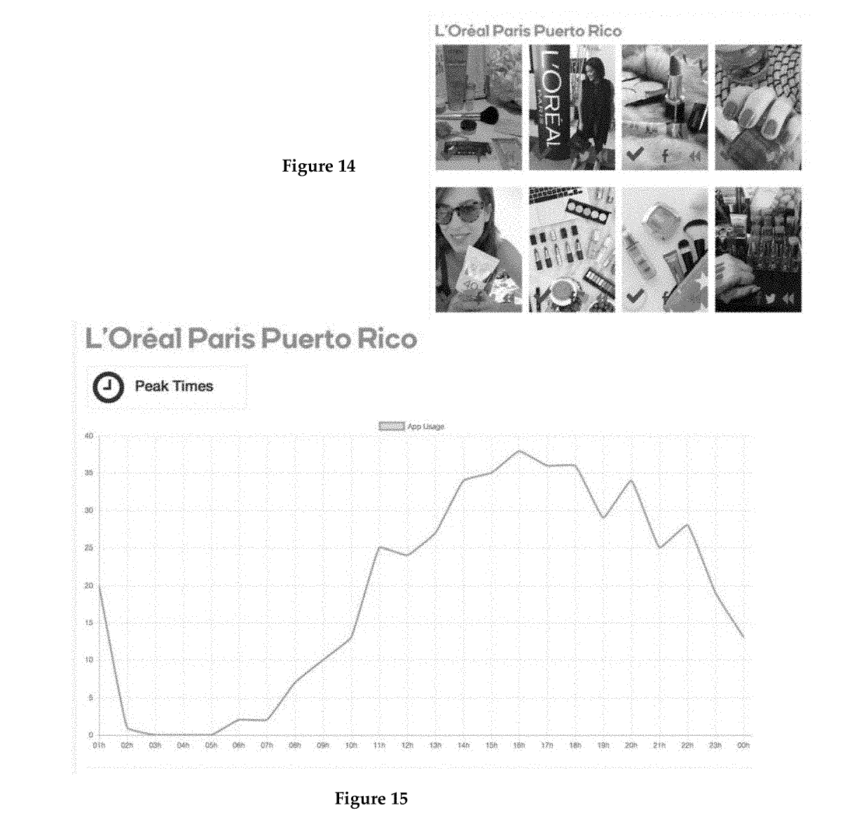

An important feature of the SELFEE system is the sponsor dashboard. In it, the sponsors can see how the sponsorship of a particular brand/event/product is going. FIGS. 13-15 illustrate some examples of the overall data that may be present. In one dashboard image 1300 we see the overall situation for a SELFEE customer (L'Oreal, in this case the sponsor). In this example, each brand interaction is priced at 50 cents, with the brand establishing a $5,000 budget (maximum expenditure). Since it resulted in 69 SELFEE images (example interaction images in FIG. 14), a total of 919 Likes (in all social media platforms), 219 ‘Loves” and 0 shares and comments, a resulting 1,338 interactions! The SELFEE system calculates and pay $569 to the 69 SELFEE image originators (leaving a balance of $4,431 unspent). As seen in FIG. 15, the data of user interaction may be displayed over the day.

### User Platform

Utilizing Microsoft's Xamarin we created a user software native to their phones/devices (204, 206, 208, 210) using iOS and Android, that lets them take pictures, integrate photo filters, and write messages to post in their social media platforms, while tracking (with their permission) that contents data. Within the App users select the category or type of picture they are going to take, take the picture, apply a filter and post them to social media. Within the App our software recognizes content, faces and brands on the pictures. This recognition triggers the Recognition API to identify that person. If user is already registered in SELFEE, our platform will identify the user and save that users image.

### Server-Side Platform

Utilizing Microsoft Azure scalable server platform, we centralize all the processing from our different APIs and technologies, this serves 218 as the main brain of our platform, that communicates with the User Platform, the Client CMS, The Administration CMS, The Content, Face and Logo recognition software, Email Platform, Payout Platform, Unique Algorithms and Social Media integration APIs. Utilizing SQL servers all data is compiled, and saved in complex integrated structures that permits us analyze the data create a digital canvas of social interactions.

### Brands, Logo and Element Recognition

One of the main features that The SELFEE App offers is that the system recognized the presence of brands in the content shared by the user. Through various Cognitive Services we scan the users content and determine if the users face is present, if there are Brand Logos present and which, and identify any other element that there is in the content. This process is done automatically and tags it so that the data is compiled in an organized matter.

### Administrator Platform

In order for the system to work we developed a web based administration platform so that administrators can review how the system is performing, review the content being shared and setup the payout system, so that the users can get rewarded after sharing their content. Within this administration platform certified personnel, create campaigns, monitor user content, validates users, monitors overall social activity of content and manages how and when users are being rewarded. In one example screen FIG. 15 we see the possible scenario of collected data about all user's actions with regards to one brand or one product of said brand.

### Inappropriate Content Filters

We integrated an inappropriate content filter 902, that scrutinizes the content users shared for adult and violent images. Based on machine learning our API integration can identify if a photograph has adult or violent content. Once that image is identified it is flagged and marked as unverified so that users do not get rewarded for that type of content.

### Email Platform

In order to communicate more efficiently with our users, we developed an email integration platform 904 so that we could periodically send users information about their content and how they are doing in regard to content sharing and social media activity. This email platform is controlled by system administrators, but is automatically integrated with our system so that it is up to date with all the recent data.

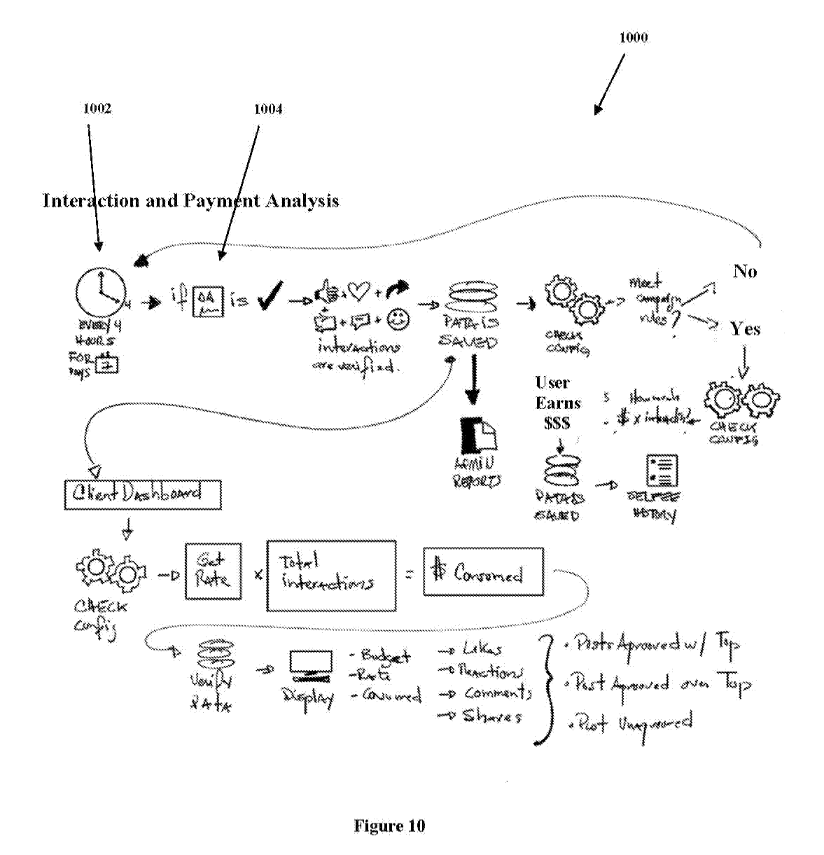

As far as the Interaction and Payout (FIG. 10) we see the Analysis tree 1000. In one embodiment, the payoff analysis is done every four hours 1002 for a total of 7 days (any specific period may be selected). When the SELFEE user's 202 image is detected 1004 the interactions are then verified, and the data is saved (both to the user's record and to the Admin Report), the configuration is checked and if the campaign rules for the LOGO are met, the payment is credited to the user's records.

The SELFEE users 202 are constantly creating content and generating interactions, those interactions have value, and once the user gets to a specified threshold he or she can request a payout. Our system then processes that request and deposits the corresponding amount of money to the users selected payout method. We developed a unique payout platform that permits us deposit money to the user's bank account and Pay Pal account.

We have developed unique algorithms that constantly are calculating the social media interactions and their value so that the users have the information always at the moment on how their content is doing and how much money they have generated.

### Client Platform

Through the SELFEE App, our clients (brands) can log in to their own area and see how their campaigns are doing, how many users are sharing content with their brands and how well the social media universe is reacting to that content, tracking shares, likes, reactions, retweets and comments. Campaigns are defined as periods of time backed by a budget that users share content with that specific brand. This budget is utilized to reward the user for the content they shared.

### CONCLUSION

In concluding the detailed description, it should be noted that it would be obvious to those skilled in the art that many variations and modifications can be made to the preferred embodiment without substantially departing from the principles of the present invention. Also, such variations and modifications are intended to be included herein within the scope of the present invention as set forth in the appended claims. Further, in the claims hereafter, the structures, materials, acts and equivalents of all means or step-plus function elements are intended to include any structure, materials or acts for performing their cited functions.

It should be emphasized that the above-described embodiments of the present invention, particularly any “preferred embodiments” are merely possible examples of the implementations, merely set forth for a clear understanding of the principles of the invention. Any variations and modifications may be made to the above-described embodiments of the invention without departing substantially from the spirit of the principles of the invention. All such modifications and variations are intended to be included herein within the scope of the disclosure and present invention and protected by the following claims.

The present invention has been described in sufficient detail with a certain degree of particularity. The utilities thereof are appreciated by those skilled in the art. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

1. A method for tracking and rewarding social media influencers, said method comprising:
capturing by the camera of an electronic computing device an image, with the electronic computing device ensuring the capture of available geolocation and/or time information, and user comments and input, manual or automated including recognition of content, brand(s) and/or persons in image;
uploading said image to one or more SELFEE server computing devices, wherein said images are checked for appropriate content, manual or automated recognition of brand(s) logo/products/people, correct time/place and approval for reward tracking;
posting said images to one or more social media networks;
tracking replies to user posted images in one or more social media networks and calculating rewards per user; and
remitting rewards to users.

2. the method according to claim 1 wherein;
the computing device camera is under the explicit control of the SELFEE application on said computing device.

3. the method according to claim 2 wherein;
images having one or more person(s) besides the user in them are not approved by the SELFEE system for reward tracking until said one or more person(s) authorize their use to the SELFEE system.

4. the method according to claim 1 wherein;
images having one or more person(s) besides the user in them are not approved by the SELFEE system for reward tracking until said one or more person(s) authorize their use to the SELFEE system.

5. A Social Media influencer tracking and rewarding system comprising;
one or more processors;
a memory, wherein the memory coupled to the one or more processors which are configured to execute programmed instructions stored in the memory comprising: receiving a data set comprising at least one selected topic;
capturing by the camera of an electronic computing device an image, with the electronic computing device ensuring the capture of available geolocation and/or time information, and user comments and input, manual or automated including recognition of content, brand(s) and/or persons in image;
uploading said image to one or more SELFEE server computing devices, wherein said images are checked for appropriate content, manual or automated recognition of brand(s) logo/products/people, correct time/place and approval for reward tracking;
posting said images to one or more social media networks;
tracking replies to user posted images in one or more social media networks and calculating rewards per user; and
remitting rewards to users.

6. the system of claim 5 wherein;
the computing device camera is under the explicit control of the SELFEE application on said computing device.

7. the system of claim 6 wherein;
images having one or more person(s) besides the user in them are not approved by the SELFEE system for reward tracking until said one or more person(s) authorize their use to the SELFEE system.

8. the system of claim 5 wherein;
images having one or more person(s) besides the user in them are not approved by the SELFEE system for reward tracking until said one or more person(s) authorize their use to the SELFEE system.

9. A non-transitory computer readable medium having stored thereon instructions for tracking and rewarding at least one influencer comprising machine executable code which when executed by at least one processor, causes the processor to perform steps comprising:
capturing by the camera of an electronic computing device an image, with the electronic computing device ensuring the capture of available geolocation and/or time information, and user comments and input, manual or automated including recognition of content, brand(s) and/or persons in image;
uploading said image to one or more SELFEE server computing devices, wherein said images are checked for appropriate content, manual or automated recognition of brand(s) logo/products/people, correct time/place and approval for reward tracking;
posting said images to one or more social media networks;
tracking replies to user posted images in one or more social media networks and calculating rewards per user; and
remitting rewards to users.

10. the medium as set forth in claim 9 wherein;
the computing device camera is under the explicit control of the SELFEE application on said computing device.

11. the medium as set forth in claim 10 wherein;
images having one or more person(s) besides the user in them are not approved by the SELFEE system for reward tracking until said one or more person(s) authorize their use to the SELFEE system.

12. the medium as set forth in claim 9 wherein;
images having one or more person(s) besides the user in them are not approved by the SELFEE system for reward tracking until said one or more person(s) authorize their use to the SELFEE system.
